(19) United States
(12) Patent Application Publication
(10) Pub. No.: US 2024/0205960 A1
(43) Pub. Date: Jun. 20, 2024

(54) INFORMATION PROCESSING DEVICE, INFORMATION PROCESSING METHOD, AND COMMUNICATION SYSTEM

(71) Applicant: SONY GROUP CORPORATION, TOKYO (JP)

(72) Inventor: JUNGO GOTO, TOKYO (JP)

(21) Appl. No.: 18/556,913

(22) PCT Filed: Mar. 7, 2022
(86) PCT No.: PCT/JP2022/009827

§ 371 Date: Oct. 24, 2023

(30) Foreign Application Priority Data
May 13, 2021 (JP) 2021-081938

(51) Int. Cl. H04W 72/56; H04W 52/18

(52) U.S. Cl. CPC H04W 72/56; H04W 52/18

(57) ABSTRACT

An information processing device (10) controls a device (60) by means of communication via a core network (200). The information processing device (10) includes a control unit (130). The control unit (130) determines levels of priority of a plurality of pieces of traffic to and from the device (60) according to control over the device (60). The control unit (130) notifies the core network (200) of priority information regarding the levels of priority.

### FIELD

The present disclosure relates to an information processing device, an information processing method, and a communication system.

### BACKGROUND

In NR, a slicing technology for putting a plurality of forms of communication corresponding to various use cases together into one network has been studied. According to the slicing technology, logical networks called slices (also referred to as network slices) can coexist in one physical network. As for the slicing technology, for example, Patent Literature 1 discloses a technology in which a service server of a service provider gives an instruction for switching a network slice applied to a user terminal.

### CITATION LIST

### Patent Literature

Patent Literature 1: JP 2021-22889 A

### SUMMARY

### Technical Problem

The slicing technology enables bandwidth guaranteed communication. Since the bandwidth is guaranteed, a device residing at a remote location can be controlled in a stable manner. In such control of the remote device, not only is required low delay for both the downlink and the uplink, but handling of pieces of traffic requiring a plurality of levels of priority is also required. In this manner, in control of a device residing at a remote location, for example, it is desirable to appropriately perform priority control of a plurality of pieces of traffic.

Therefore, the present disclosure proposes an architecture capable of appropriately performing priority control of a plurality of pieces of traffic in control of a device residing at a remote location, for example.

Note that the above problem or object is merely one of a plurality of problems or objects that can be solved or achieved by the plurality of embodiments disclosed in the present specification.

### Solution to Problem

According to the present disclosure, an information processing apparatus is provided. The information processing device controls a device by means of communication via a core network. The information processing device includes a control unit. The control unit determines levels of priority of a plurality of pieces of traffic to and from the device according to control over the device. The control unit notifies the core network of priority information regarding the levels of priority.

### BRIEF DESCRIPTION OF DRAWINGS

FIG. 1 is a diagram for describing an overview of a communication system according to an embodiment of the present disclosure.

FIG. 2 is a diagram for describing an example of a level of priority according to the embodiment of the present disclosure.

FIG. 3 is a diagram illustrating a configuration example of the communication system according to the embodiment of the present disclosure.

FIG. 4 is a diagram illustrating a configuration example of a core network according to the embodiment of the present disclosure.

FIG. 5 is a block diagram illustrating a configuration example of an information processing device according to the embodiment of the present disclosure.

FIG. 6 is a block diagram illustrating a configuration example of a base station according to the embodiment of the present disclosure.

FIG. 7 is a diagram for describing an example of priority setting in the core network according to the embodiment of the present disclosure.

FIG. 8 is a diagram for describing another example of priority setting in the core network according to the embodiment of the present disclosure.

FIG. 9 is a block diagram illustrating a configuration example of a resource control unit according to the embodiment of the present disclosure.

FIG. 10 is a table illustrating a priority setting example in the communication system according to the embodiment of the present disclosure.

FIG. 11 is a flowchart illustrating an example of priority setting processing executed by the information processing device according to the embodiment of the present disclosure.

FIG. 12 is a sequence diagram illustrating an example of priority setting processing executed in the core network according to the embodiment of the present disclosure.

FIG. 13 is a sequence diagram illustrating another example of priority setting processing executed in the core network according to the embodiment of the present disclosure.

FIG. 14 is a flowchart illustrating an example of priority setting processing executed by the base station according to the embodiment of the present disclosure.

FIG. 15 is a diagram for describing a flow of processing according to a modification example of the embodiment of the present disclosure.

FIG. 16 is a diagram illustrating examples of services provided by a NEF.

### DESCRIPTION OF EMBODIMENTS

Hereinbelow, embodiments of the present disclosure will be described in detail with reference to the accompanying drawings. Note that, in the present specification and the drawings, components having substantially the same functional configurations are labeled with the same reference signs, and redundant description is omitted.

In addition, in the present specification and the drawings, a plurality of components having substantially the same functional configurations may be distinguished by attaching different alphabets to the ends of the same reference signs. For example, a plurality of components having substantially the same functional configurations are distinguished as control target devices 60A, 60B, and 60C as necessary. However, in a case in which it is not particularly necessary to distinguish the plurality of components having substantially the same functional configurations from each other, only the same reference signs are attached. For example, in a case where it is not necessary to particularly distinguish the control target devices 60A, 60B, and 60C, they are simply referred to as control target devices 60.

One or a plurality of embodiments (including examples and modification examples) described below can each be carried out independently. On the other hand, at least some of the plurality of embodiments described below may appropriately be combined with at least some of other embodiments. The plurality of embodiments may include novel features different from each other. Therefore, the plurality of embodiments can contribute to solving different objects or problems, and can exhibit different effects.

### <<1. Overview of Communication System>>

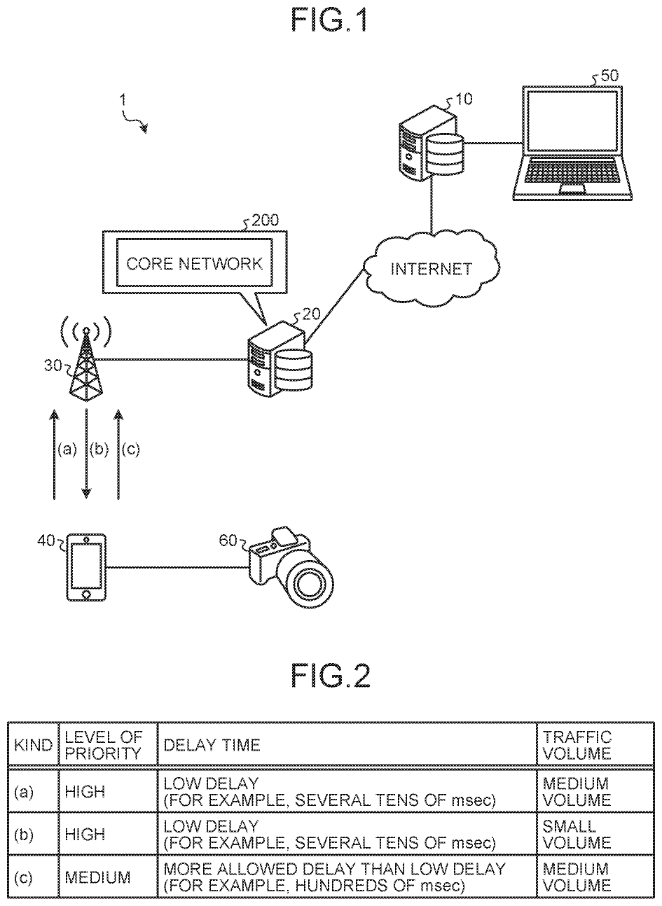

FIG. 1 is a diagram for describing an overview of a communication system 1 according to an embodiment of the present disclosure. As illustrated in FIG. 1, the communication system 1 includes an information processing device 10, a server 20, a base station 30, a terminal device 40, an input/output device 50, and a control target device 60. In the server 20, a core network 200 is constructed.

### [Information Processing Device 10]

The information processing device 10 controls the control target device 60 residing at a remote location by the information processing device 10 on the basis of control information input by a user via the input/output device 50. As described below, in a case where the control target device 60 is, for example, a camera, the information processing device 10 performs control operations such as transmission of a preview, capturing of a still image, and uploading of a captured image. The information processing device 10 performs these control operations by using communication via the core network 200, the base station 30, and the terminal device 40.

In addition, the information processing device 10 sets levels of priority (for example, quality of service (QoS)) of a plurality of pieces of traffic between the information processing device 10 and the control target device 60. For example, as illustrated in FIG. 1, the following pieces of traffic may occur between the control target device 60 and the information processing device 10.
(a) Uplink traffic for transmitting a preview image
(b) Downlink traffic for transmitting control information to the control target device 60, such as a shutter instruction
(c) Uplink traffic for transmitting a captured image

Here, an example of a level of priority set by the information processing device 10 will be described with reference to FIG. 2. FIG. 2 is a diagram for describing an example of a level of priority according to the embodiment of the present disclosure.

The traffic (a) illustrated in FIG. 2 is uplink traffic for transmitting a preview image as described above. Therefore, the traffic volume is larger than that of control information or the like to be described below, and is, for example, a medium volume.

In addition, the user checks the preview image to determine a time or the like when the shutter is released. Therefore, as delay time of the preview image, for example, a low delay of about several tens of msec is required.

The traffic (b) is downlink traffic for transmitting control information as described above. Therefore, the traffic volume is smaller than that of the preview image or the like, and is, for example, a small volume.

Furthermore, it is desirable that the control target device 60 be controlled with no delay. For example, the control target device 60 should release the shutter at a shutter time specified by the user. Therefore, as delay time of the control information, for example, a low delay of about several tens of msec is required.

The traffic (c) is uplink traffic for transmitting a captured image as described above. Therefore, the traffic volume is larger than that of control information or the like to be described below, and is, for example, a medium volume.

Furthermore, the captured image only needs to be able to be checked by the user later, and is not required to be presented to the user with no delay after capturing. Therefore, the required delay time has more allowed delay (for example, delay time of about hundreds of msec) than in a case where low delay is required as in the preview image and the control information.

In this manner, for the traffic between the information processing device 10 and the control target device 60, for example, the traffic volume and the delay time according to the kind of traffic are required. Therefore, the information processing device 10 sets levels of priority of a plurality of pieces of traffic according to the kind of traffic, that is, the operation (including control operations such as a preview image transmission instruction and a shutter instruction) over the control target device 60.

In the example of FIG. 2, the information processing device 10 sets a level of priority of (a) traffic for transmitting a preview image to the highest level, for example, “high”. The information processing device 10 sets a level of priority of (b) traffic for transmitting control information to the highest level, for example, “high”. The information processing device 10 sets a level of priority of (c) traffic for transmitting a captured image to a lower level than (a) and (b), for example, “medium”.

FIG. 1 is referred to again. The information processing device 10 notifies the core network 200 of set information regarding priority.

### [Core Network 200]

The core network 200 is constructed in, for example, the server 20. The core network 200 acquires information regarding priority of the traffic from the information processing device 10. The core network 200 sets, for example, a PDU session on the basis of the acquired information regarding priority. The core network 200 performs QoS control according to the level of priority of the traffic by, for example, setting a QoS flow of a PDU session on the basis of the acquired information. The core network 200 also sets a network slice according to the level of priority of the traffic, for example. In this manner, the core network 200 dynamically controls QoS and a network slice on the basis of the information acquired from the information processing device 10.

In addition, the core network 200 notifies the base station 30 of the information regarding priority set by the information processing device 10.

### [Base Station 30]

The base station 30 performs, for example, radio communication with the terminal device 40. The base station 30 transmits to the terminal device 40 data (for example, control information) transmitted from the information processing device 10 via the core network 200. Furthermore, the base station 30 transmits to the information processing device 10 via the core network 200 data (for example, a preview image and a captured image) transmitted from the terminal device 40.

At this time, the base station 30 performs communication control according to the priority notified from the core network 200. For example, the base station 30 performs resource control, transmission power control, and the like according to the priority of the traffic.

### [Terminal Device 40]

The terminal device 40 is connected to, for example, the control target device 60 and relays communication performed by the control target device 60. That is, the terminal device 40 operates as a primary device for tethering, for example.

### [Control Target Device 60]

The control target device 60 is a device that operates according to control from the information processing device 10. In the example of FIG. 1, the control target device 60 is a camera that captures a still image, but is not limited thereto. For example, the control target device 60 may be a camera that captures a moving image. Note that the control target device 60 is not limited to a camera as long as it operates under the control of the information processing device 10 and notifies the information processing device 10 of the control result.

The control target device 60 is connected to the terminal device 40 and transmits data to the information processing device 10 via the terminal device 40. The control target device 60 operates as a subordinate device for tethering, for example.

### [Input/Output Device 50]

The input/output device 50 is a device that outputs information regarding the control target device 60 acquired from the information processing device 10 and receives an input regarding control (operation) over the control target device 60 from the user. The input/output device 50 displays, for example, a preview image and a captured image. Furthermore, the input/output device 50 notifies the information processing device 10 of an operation over the control target device 60 performed by the user, such as a shutter instruction, as control information.

The input/output device 50 can include peripheral devices of the information processing device 10, such as a display and a keyboard. Alternatively, the input/output device 50 may be a device (information processing device) that can perform information processing, such as a PC and a tablet terminal.

As described above, the information processing device 10 sets levels of priority of a plurality of pieces of traffic according to the control over the control target device 60, and the core network 200 and the base station 30 perform communication control according to the levels of priority.

For example, the core network 200 and the base station 30 perform communication control so that the preview image and the control information, set to high priority by the information processing device 10, are transmitted with low delay. Furthermore, the captured image, set to low priority by the information processing device 10, is transmitted using, for example, an empty resource so as not to affect traffic with high priority.

In this manner, the information processing device 10 sets levels of priority of a plurality of pieces of traffic according to the control over the control target device 60, so that the communication system 1 can dynamically perform priority control (for example, QoS control) of traffic. Accordingly, the communication system 1 can perform more appropriate priority control.

### <<2. Configuration Example of Communication System>>

### <2.1. Overall Configuration Example of Communication System>

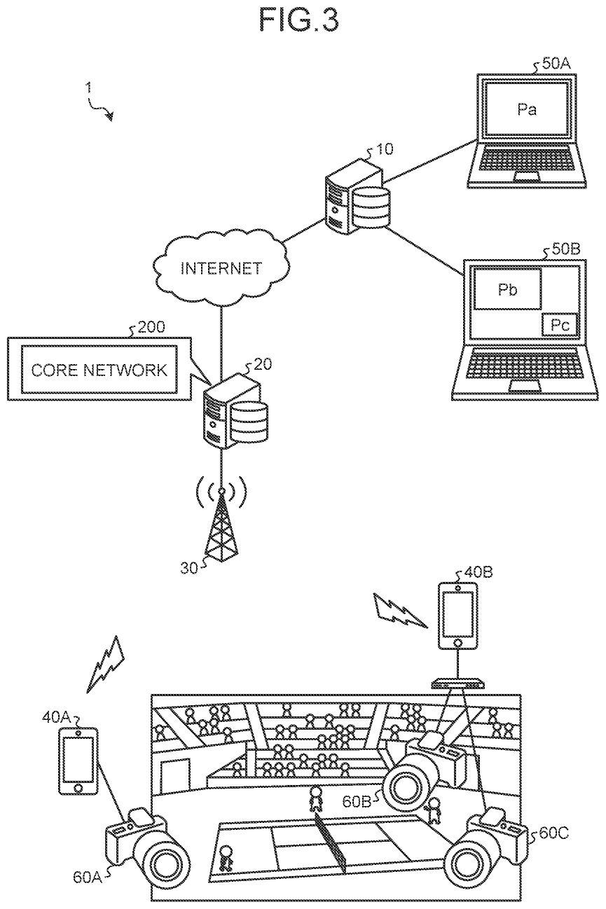

FIG. 3 is a diagram illustrating a configuration example of the communication system 1 according to the embodiment of the present disclosure. In the example illustrated in FIG. 3, the communication system 1 includes the information processing device 10, the server 20, the base station 30, a plurality of terminal devices 40A and 40B, a plurality of input/output devices 50A and 50B, and a plurality of control target devices 60A to 60C. In the server 20, a core network 200 is constructed.

As illustrated in FIG. 3, the communication system 1 may include a plurality of terminal devices 40. In FIG. 3, the number of the terminal devices 40 is two, but is not limited thereto. The number of the terminal devices 40 may be one or three or more.

At least one control target device 60 can be connected to each of the terminal devices 40. In the example of FIG. 3, one control target device 60 is connected to the terminal device 40A. In addition, two control target devices 60B and 60C are connected to the terminal device 40B. Note that the number of the control target devices 60 connected to each of the terminal devices 40 is not limited to two or less, and may be three or more.

As illustrated in FIG. 3, the communication system 1 may include a plurality of input/output devices 50. The plurality of input/output devices 50 receives a user operation over at least one control target device 60, and displays information (for example, a preview image or a captured image) received from the control target device 60.

In the example of FIG. 3, the input/output device 50A displays a preview image Pa of the control target device 60A and receives an operation over the control target device 60A. The input/output device 50B displays preview images Pb and Pc of the control target devices 60B and 60C, and receives operations over the control target devices 60B and 60C.

Note that, in FIG. 3, for example, on the basis of an instruction from the user, the input/output device 50B displays the preview image of the control target device 60B (hereinbelow, it is also referred to as a main device), which is a main control target, to be larger than the preview image of the control target device 60C (hereinbelow, it is also referred to as a sub device), which is a sub control target. The main device is the control target device 60 to be operated by the user, and the sub device is the control target device 60 not to be operated by the user.

In this manner, the input/output device 50 presents information regarding the corresponding control target device 60 to the user, and receives an operation over the control target device 60 from the user. Note that the number of the control target devices 60 corresponding to the input/output device 50 is not limited to two or less, and may be three or more.

### <2.2. Configuration Example of Core Network>

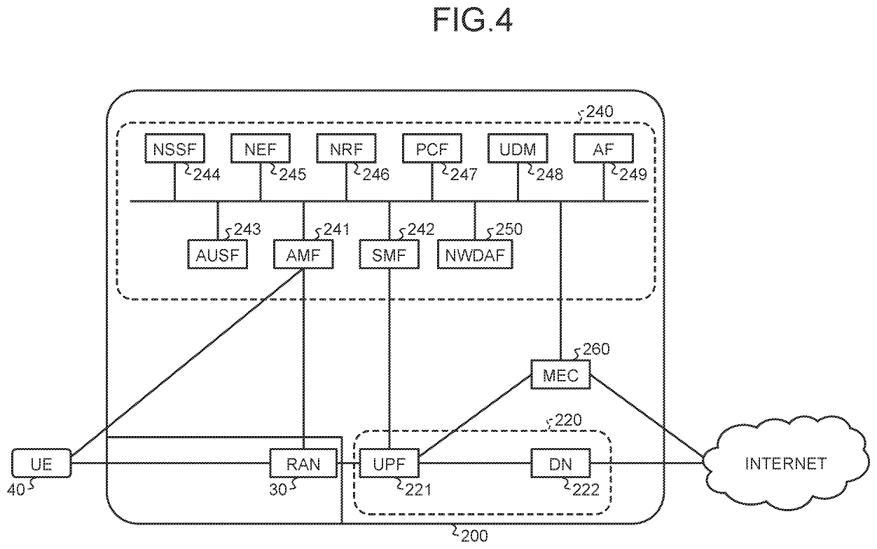

Next, the core network 200 according to the embodiment of the present disclosure will be described with reference to FIG. 4. Here, a case where the core network 200 is a core network of a fifth generation mobile communication system (5G) will be described, but the present disclosure is not limited thereto. The core network 200 may be a core network of another radio access scheme such as long term evolution (LTE).

FIG. 4 is a diagram illustrating a configuration example of the core network 200 according to the embodiment of the present disclosure. The 5G core network 200 is also referred to as 5GC (5G Core)/NGC (Next Generation Core). Hereinbelow, the 5G core network 200 is also referred to as the 5GC/NGC 200. The 5GC/NGC 200 is connected to user equipment (UE) via a (R)AN. Note that the UE is an example of the terminal device 40, and hereinbelow, the terminal device 40 is also referred to as the UE 40.

The (R)AN has a function of enabling connection to a radio access network (RAN) and connection to an access network (AN) other than the RAN. The (R)AN includes a base station device called a gNB or an ng-eNB. The base station 30 corresponds to, for example, the gNB of the (R)AN. Hereinbelow, the base station 30 is also referred to as the (R)AN 30.

The 5GC/NGC 200 includes a user plane function group 220, a control plane function group 240, and a mobile edge computing (MEC, also referred to as multi access edge computing) 160.

The user plane function group 220 includes a user plane function (UPF) 221 and a data network (DN) 222. The UPF 221 has a function of user plane processing. The UPF 221 includes a routing/forwarding function of data handled in a user plane. The DN 222 has a function of enabling connection to a service unique to a cellular service provider 3000, the Internet, or a third-party service. However, although the DN is included in the core network 200 in FIG. 4, the DN may be outside the core network 200.

The control plane function group 240 includes an access management function (AMF) 241, a session management function (SMF) 242, an authentication server function (AUSF) 243, a network slice selection function (NSSF) 244, a network exposure function (NEF) 245, a network repository function (NRF) 246, a policy control function (PCF) 247, a unified data management (UDM) 248, an application function (AF) 149, and a network data analytics function (NWDAF) 150.

The AMF 241 has functions of registration processing, connection management, mobility management, and the like of the UE 40. The SMF 242 has functions of session management, IP assignment and management of the UE 40, and the like. The AUSF 243 has an authentication function. The NSSF 244 has a function related to selection of a network slice. The NEF 245 has a function of providing a capability and an event of a network function to a third party, an application function, and an edge computing function.

The NRF 246 has a function of finding a network function and holding a profile of the network function. The PCF 247 has a function of policy control. The UDM 248 has functions of generating 3GPP AKA authentication information and processing a user ID. The AF 149 has a function of interacting with the core network to provide a service. The NWDAF 250 has a function of processing network analysis.

Here, the number of applications in which a processing device (for example, a cloud server) on a network and the UE 40 perform processing in cooperation with each other is increasing. In a case where the cloud server performs part of the processing for the application, the UE 40 and the cloud server need to exchange information on the network, which causes processing delay to inevitably occur. However, some application may not allow a large processing delay. In recent years, edge computing that causes a cloud server at a position close to a device that executes an application to perform processing has begun to be known as a technique for achieving low delay processing. The MEC 160 of the 5GC 200 illustrated in FIG. 4 has such an edge computing function.

### <2.3. Configuration Example of Information Processing Device>

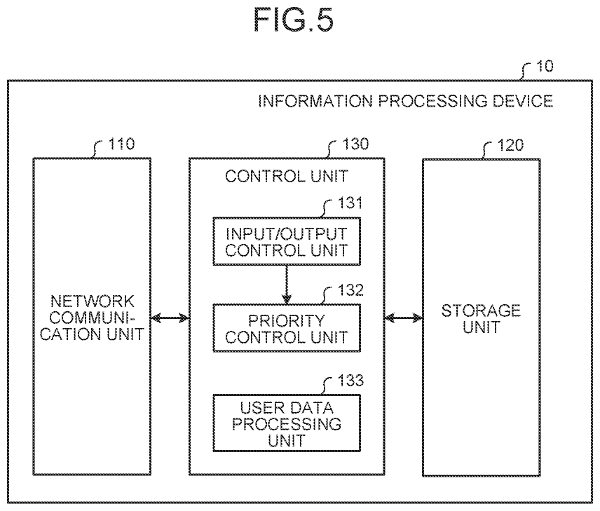

FIG. 5 is a block diagram illustrating a configuration example of the information processing device 10 according to the embodiment of the present disclosure. The information processing device 10 illustrated in FIG. 5 includes a network communication unit 110, a storage unit 120, and a control unit 130. Note that the configuration illustrated in FIG. 5 is a functional configuration, and the hardware configuration may be different from the functional configuration. Furthermore, the functions of the information processing device 10 may be implemented in a distributed manner in a plurality of physically separated configurations. For example, the information processing device 10 may include a plurality of server devices.

The network communication unit 110 is a communication interface for communicating with other devices. The network communication unit 110 may be a network interface or a device connection interface. For example, the network communication unit 110 may include a local area network (LAN) interface such as a network interface card (NIC), or may include a USB interface configured by a universal serial bus (USB) host controller, a USB port, or the like. Furthermore, the network communication unit 110 may be a wired interface or a wireless interface. The network communication unit 110 functions as a communication unit of the information processing device 10. The network communication unit 110 communicates with the NEF 245 of the core network 200 under the control of the control unit 130.

The storage unit 120 is a data readable/writable storage device such as a dynamic random access memory (DRAM), a static random access memory (SRAM), a flash memory, and a hard disk. The storage unit 120 functions as a storage unit of the information processing device 10.

The control unit 130 is a controller that controls each of the units of the information processing device 10. The control unit 130 is achieved by, for example, a processor such as a central processing unit (CPU) and a micro processing unit (MPU). For example, the control unit 130 is achieved by the processor executing various programs stored in a storage device inside the information processing device 10 using a random access memory (RAM) or the like as a working area. Note that the control unit 130 may be achieved by an integrated circuit such as an application specific integrated circuit (ASIC) and a field programmable gate array (FPGA). Any of the CPU, the MPU, the ASIC, and the FPGA can be regarded as a controller.

Note that the respective functions of the information processing device 10 may be achieved as a function of the AF 149 in the 5GC/NGC 200 illustrated in FIG. 4.

The control unit 130 includes an input/output control unit 121, a priority control unit 132, and a user data processing unit 133. The respective blocks (the input/output control unit 121 to the user data processing unit 133) constituting the control unit 130 are functional blocks indicating functions of the control unit 130. These functional blocks may be software blocks or hardware blocks. For example, each of the functional blocks described above may be one software module achieved by software (including a microprogram), or may be one circuit block on a semiconductor chip (die). Of course, each of the functional blocks may be one processor or one integrated circuit. A configuration method of the functional blocks is freely selected. Note that the control unit 130 may be constituted by different functional units from the above-described functional blocks.

### (Input/Output Control Unit 131)

The input/output control unit 131 receives an operation from the user via the input/output device 50. Furthermore, the input/output control unit 131 presents user data received by the user data processing unit 133 to the user via the input/output device 50, for example.

For example, in a case where the input/output control unit 131 receives an instruction to start an application for operating the control target device 60 from the user, the input/output control unit 131 starts the application. In a case where there are a plurality of control target devices 60 to be operated, the input/output control unit 131 presents, to the user, information for selecting the control target device 60 to be mainly operated.

On the basis of an instruction from the user, the input/output control unit 131 notifies the priority control unit 132 of information regarding the control target device 60 that is operated as the main device and the control target device 60 that is not operated as the main device but as the sub device.

The input/output control unit 131 presents user data (for example, a preview image) received from the user data processing unit 133 to the user in a form corresponding to the main device and the sub device. For example, in a case where a preview image is presented to the user, the input/output control unit 131 presents the preview image of the main device to be larger than the preview image of the sub device.

The input/output control unit 131 receives, from the user, a switching operation of the main device and an operation over the main device such as an instruction of a shutter operation, for example. The input/output control unit 131 notifies the priority control unit 132 of the received operation as operation information.

### (Priority Control Unit 132)

The priority control unit 132 determines levels of priority of a plurality of pieces of traffic according to a user operation acquired via the input/output control unit 121. For example, in a case where a PDU session is established for each piece of traffic in the core network 200, the priority control unit 132 sets a level of priority for each PDU session. Alternatively, in a case where a PDU session is established for each level of priority in the core network 200, the priority control unit 132 sets a level of priority according to the kind of traffic.

The priority control unit 132 sets a level of priority according to the traffic generated according to a user operation, for example, on the basis of priority setting information in which traffic and a level of priority are associated with each other. The priority setting information is stored in the storage unit 120, for example.

Here, an example of a level of priority set by the priority control unit 132 will be described. Here, a case where a main device (for example, the control target device 60B) as a camera captures a still image (refer to FIG. 3) will be described.

In this case, the priority control unit 132 sets levels of priority of the following pieces of traffic (or PDU sessions) to “high”.
Preview image of the control target device 60B as the main device
Control command over the control target device 60B as the main device
Instruction command for switching the main device

The control command over the main device includes a control instruction (control information) to be issued to the control target device 60B for capturing a still image such as a shutter command for instructing a shutter operation, an autofocus command, and a zoom command.

Also, the priority control unit 132 sets levels of priority of the following pieces of traffic (or PDU sessions) to “medium”.
Upload of a captured still image (captured image)
Information regarding communication with the terminal device 40

Such information regarding communication includes, for example, information regarding a buffering status of data (for example, a captured image) transmitted from the terminal device 40 to the information processing device 10, and information regarding communication notified from the information processing device 10 to the terminal device 40. An example of the information regarding communication will be described below in, for example, modification examples.

The priority control unit 132 sets levels of priority of the following pieces of traffic (or PDU sessions) to “low”.
Preview image of the control target device 60A as the sub device
Device information used for operation of the control target device 60

The device information includes information used as auxiliary information when the user operates the device, such as position information of the control target device 60 and information regarding a capturing direction.

Note that the pieces of traffic described above are examples, and the priority control unit 132 may set levels of priority for other pieces of traffic. Furthermore, the levels of priority set by the priority control unit 132 are examples, and other levels of priority may be set for the above-described pieces of traffic. For example, the preview image of the control target device 60A, which is the sub device, may have a level of priority of “medium”.

The priority control unit 132 notifies the core network 200 of priority set information regarding priority via, for example, the NEF 245.

For example, the priority information includes, as packet flow description (PFD) management, an application ID, an AF transaction internal ID, a PFD, and allowed delay.

For example, the priority control unit 132 notifies the core network 200 of whether the control target device 60 is a main device (selected device) or a sub device (unselected device) by using the AF transaction internal ID.

The priority control unit 132 sets a different allowed delay depending on the level of priority, for example, and notifies the core network 200 of the set allowed delay. For example, the priority control unit 132 can set a different allowed delay depending on whether the control target device 60 is a main device or a sub device. For example, the priority control unit 132 sets the allowed delay of the main device to 50 msec and sets the allowed delay of the sub device to 200 msec.

Note that, for example, in a case where an operation over the control target device 60 by the user, such as switching the main device, is acquired from the input/output control unit 131, the priority control unit 132 resets a level of priority. In a case where the level of priority of the traffic is reset and changed, the priority control unit 132 notifies the core network 200 of priority information regarding the changed level of priority via the NEF 245. At this time, the priority control unit 132 can notify the changed priority information by updating the PFD information by update of Nnef_PFDManagement, for example.

### <2.4. Configuration Example of Base Station>

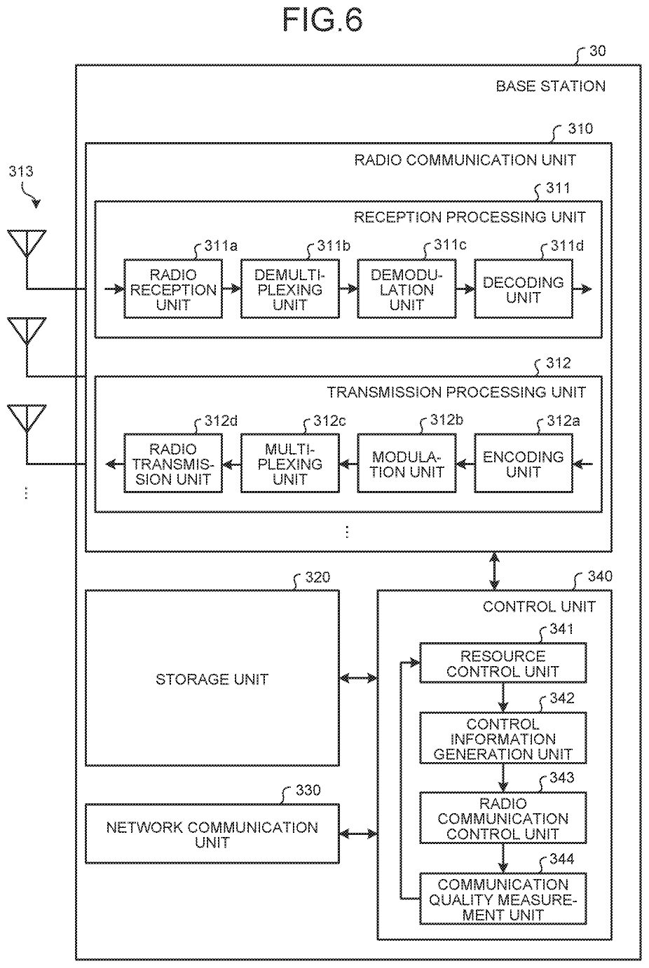

FIG. 6 is a block diagram illustrating a configuration example of the base station 30 according to the embodiment of the present disclosure. The base station 30 includes a radio communication unit 310, a storage unit 320, a network communication unit 330, and a control unit 340. Note that the configuration illustrated in FIG. 6 is a functional configuration, and the hardware configuration may be different from the functional configuration. Furthermore, the functions of the base station 30 may be implemented in a distributed manner in a plurality of physically separated configurations.

The radio communication unit 310 is a radio communication interface that wirelessly communicates with other radio communication devices (for example, the UE 40 and another base station 30). The radio communication unit 310 operates under the control of the control unit 340. Note that the radio communication unit 310 may support a plurality of radio access schemes. For example, the radio communication unit 310 may support both NR and LTE. The radio communication unit 310 may support W-CDMA and cdma2000 as well as NR and LTE. Of course, the radio communication unit 310 may support a radio access scheme other than NR, LTE, W-CDMA, and cdma2000.

The radio communication unit 310 includes a reception processing unit 311, a transmission processing unit 312, and an antenna 313. The radio communication unit 310 may include a plurality of reception processing units 311, a plurality of transmission processing units 312, and a plurality of antennas 313. Note that, in a case where the radio communication unit 310 supports a plurality of radio access schemes, each unit of the radio communication unit 310 can be configured individually for each radio access scheme. For example, each of the reception processing unit 311 and the transmission processing unit 312 may be configured individually for each of LTE and NR.

The reception processing unit 311 processes an uplink signal received via the antenna 313. The reception processing unit 311 includes a radio reception unit 311a, a demultiplexing unit 311b, a demodulation unit 311c, and a decoding unit 311d.

The radio reception unit 311a performs down-conversion, removal of an unnecessary frequency component, control of an amplification level, quadrature demodulation, conversion to a digital signal, removal of a guard interval, extraction of a frequency domain signal by fast Fourier transform, and the like on the uplink signal. The demultiplexing unit 311b demultiplexes an uplink channel such as a physical uplink shared channel (PUSCH) and a physical uplink control channel (PUCCH) and an uplink reference signal from the signal output from the radio reception unit 311a. The demodulation unit 311c demodulates the received signal using a modulation scheme such as binary phase shift keying (BPSK) and quadrature phase shift keying (QPSK) on the modulation symbol of the uplink channel. The modulation scheme used by the demodulation unit 311c may be 16 quadrature amplitude modulation (QAM), 64 QAM, or 256 QAM. The decoding unit 311d performs decoding processing on the demodulated encoded bits of the uplink channel. The decoded uplink data and uplink control information are output to the control unit 264.

The transmission processing unit 312 performs transmission processing of downlink control information and downlink data. The transmission processing unit 312 includes an encoding unit 312a, a modulation unit 312b, a multiplexing unit 312c, and a radio transmission unit 312d.

The encoding unit 312a encodes the downlink control information and the downlink data input from the control unit 264 using an encoding method such as block encoding, convolutional encoding, turbo encoding, and low density parity check (LDPC) code. The modulation unit 312b modulates the encoded bits output from the encoding unit 312a by means of a predetermined modulation scheme such as BPSK, QPSK, 16 QAM, 64 QAM, and 256 QAM. The multiplexing unit 312c multiplexes the modulation symbol of each channel and the downlink reference signal and arranges the multiplexed symbol in a predetermined resource element. The radio transmission unit 312d performs various types of signal processing on the signal from the multiplexing unit 312c. For example, the radio transmission unit 312d performs processing such as conversion into a time domain by fast Fourier transform, addition of a guard interval, generation of a baseband digital signal, conversion into an analog signal, quadrature modulation, up-conversion, removal of an extra frequency component, and power amplification. The signal generated in the transmission processing unit 312 is transmitted from the antenna 313.

The storage unit 320 is a storage device capable of reading and writing data, such as a DRAM, an SRAM, a flash memory, and a hard disk. The storage unit 320 functions as a storage unit of the base station 30.

The network communication unit 330 is a communication interface for communicating with other devices (for example, the AMF 241 of the core network 200, another base station 30, and the information processing device 10). For example, the network communication unit 330 includes a LAN interface such as an NIC. Furthermore, the network communication unit 330 may be a wired interface or a wireless interface. The network communication unit 330 functions as a network communication unit of the base station 30. The network communication unit 330 communicates with other devices under the control of the control unit 340. The configuration of the network communication unit 330 may be similar to that of the network communication unit 110 of the information processing device 10.

The control unit 340 is a controller that controls each of the units of the base station 30. The control unit 340 is achieved by, for example, a processor such as a central processing unit (CPU) and a micro processing unit (MPU). For example, the control unit 340 is achieved by the processor executing various programs stored in a storage device inside the base station 30 using a random access memory (RAM) or the like as a working area. Note that the control unit 340 may be achieved by an integrated circuit such as an application specific integrated circuit (ASIC) and a field programmable gate array (FPGA). Any of the CPU, the MPU, the ASIC, and the FPGA can be regarded as a controller.

The control unit 340 includes a resource control unit 341, a control information generation unit 342, a radio communication control unit 343, and a communication quality measurement unit 344. The respective blocks (the resource control unit 341 to the communication quality measurement unit 344) constituting the control unit 340 are functional blocks indicating functions of the control unit 340. These functional blocks may be software blocks or hardware blocks. For example, each of the functional blocks described above may be one software module achieved by software (including a microprogram), or may be one circuit block on a semiconductor chip (die). Of course, each of the functional blocks may be one processor or one integrated circuit. A configuration method of the functional blocks is freely selected. Note that the control unit 340 may be constituted by different functional units from the above-described functional blocks.

### (Resource Control Unit 341)

The resource control unit 341 performs resource control for radio communication with the UE 40 on the basis of information regarding traffic acquired from the core network 200. The information regarding traffic includes, for example, information regarding the total traffic volume and link capacity. The information regarding traffic also includes information regarding a level of priority of traffic and information regarding a network slice. Note that the details of the resource control unit 341 will be described below.

### (Control Information Generation Unit 342)

The control information generating unit 342 generates control information necessary for radio communication control performed by the radio communication control unit 343 on the basis of the information regarding the resource determined by the resource control unit 341.

### (Radio Communication Control Unit 343)

The radio communication control unit 343 controls the radio communication unit 310 on the basis of the control information generated by the control information generation unit 342, and performs radio communication with the UE 40.

### (Communication Quality Measurement Unit 344)

The communication quality measurement unit 344 measures the quality of the radio communication of the radio communication control unit 343 with the UE 40. The communication quality measurement unit 344 notifies the resource control unit 341 of the measurement result.

### <<3. Exemplary Setting According to Level of Priority>>

### <3.1. Priority Setting in Core Network>

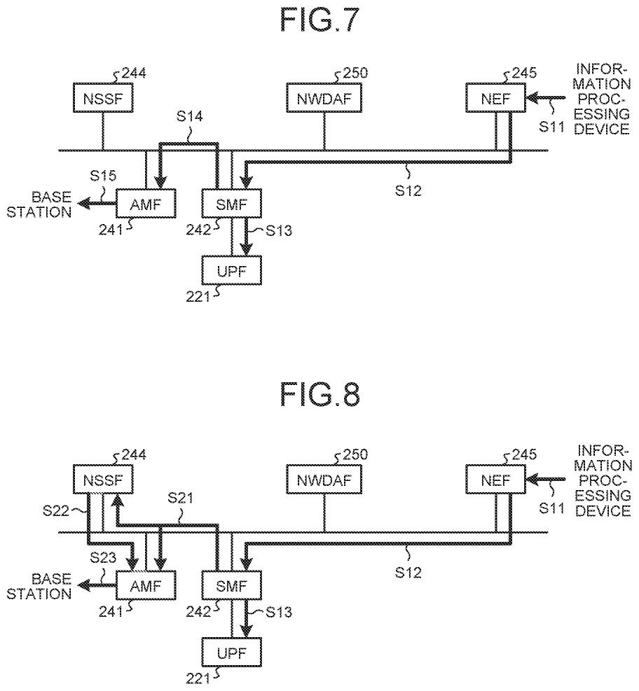

FIG. 7 is a diagram for describing an example of priority setting in the core network 200 according to the embodiment of the present disclosure. Note that FIG. 7 mainly illustrates functions related to priority setting, and does not illustrate some other functions.

As illustrated in FIG. 7, the NEF 245 receives priority information regarding priority from the information processing device 10 (step S11).

The priority information received by the NEF 245 may include, for example, the AF transaction internal ID, the PFD, and the allowed delay as described above. Here, examples of setting of parameters received as the priority information by the NEF 245 include the following.

For example, as the application ID, a common ID is set in a plurality of pieces of traffic (or PDU sessions). The AF transaction internal ID identifies the control target device 60 (not the UE 40 but any of the control target devices 60 connected to the UE 40). In addition, the PFD notifies information regarding the main device and the sub device and traffic volume (for example, the image quality of the preview, the frame rate, the compression method, and the like) of the main device and the sub device. The allowed delay notifies the delay time allowed in the main device and the sub device.

Note that, here, the priority information includes both the PFD and the allowed delay, but is not limited thereto. For example, the priority information may include either the PFD or the allowed delay.

The NEF 245 notifies the SMF 242 of the received priority information (step S12). Upon receiving the priority information, the SMF 242 notifies the UPF 221 of the priority information (step S13).

Here, examples of N4 session parameters notified from the SMF 242 to the UPF 221 as the priority information include the following.
Packet Detection Rules (PDR): Information to classify traffic (PDU) arriving at the UPF
Forwarding Action Rules (FAR): Information on whether forwarding, dropping, or buffering is to be applied to traffic identified by the PDR
Multi-Access Rules (MAR): Information on handling, switching, and splitting for the MA PDU session
Usage Reporting Rules (URR): Information that defines how traffic identified by the PDR shall be accounted as well as how a certain measurement shall be reported
QOS Enforcement Rules (QER): Information related to QoS enforcement of traffic identified by the PDR
Session Reporting Rules (SRR): Information regarding detection and report of events for a PDU session that are not related to specific PDRs of the PDU session or that are not related to traffic usage measurement
Trace requirement
Port management information container in 5GS
Bridge Information

The UPF 221 configures a network slice on the basis of the information regarding priority received from the SMF 242, such as the N4 session parameters described above, and handles the PDU session.

For example, the UPF 221 processes data of downlink and uplink PDU sessions according to levels of priority of the PDU sessions. For example, in the case of the downlink, the UPF 221 can control the data volume to be passed to the base station 30 according to the level of priority. More specifically, the UPF 221 performs data processing of the PDU session according to the level of priority. For example, in the PDU session whose level of priority is set to “low”, traffic having equal to or more than a certain volume is buffered.

In addition, the SMF 242 notifies the AMF 241 of the priority information (step S14). Note that the SMF 242 can be notified, as the priority information, of information related to priority set in the core network 200, such as whether buffering is to be applied and a guaranteed bit rate (GBR), as well as the information notified from the information processing device 10.

The SMF 242 notifies the base station 30 of the priority information received from the AMF 241 (step S15). Note that network slice allocation is performed in the NSSF 244. Therefore, the SMF 242 may notify the NSSF 244 of the priority information, and the NSSF 244 may allocate a network slice according to the priority information. This point will be described with reference to FIG. 8.

FIG. 8 is a diagram for describing another example of priority setting in the core network 200 according to the embodiment of the present disclosure. Note that FIG. 8 mainly illustrates functions related to priority setting, and does not illustrate some other functions. Note that the same steps as those in FIG. 7 are denoted by the same step numbers, and description thereof is omitted.

As illustrated in FIG. 8, the SMF 242 notifies the NSSF 244 as well as the AMF 241 of the priority information (step S21). Upon receiving the priority information, the NSSF 244 determines a network slice for the PDU session on the basis of, for example, the PFD included in the priority information, and notifies the AMF 241 of information regarding the determined network slice (step S22).

The SMF 242 notifies the base station 30 of the information regarding the network slice received from the NSSF 244 (step S23).

### <3.2. Resource Control in Base Station>

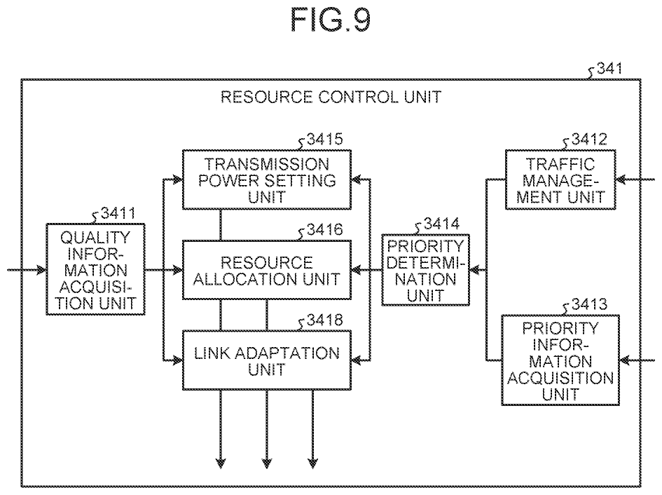

Next, an example of resource control performed in the resource control unit 341 of the base station 30 will be described with reference to FIG. 9.

FIG. 9 is a block diagram illustrating a configuration example of the resource control unit 341 according to the embodiment of the present disclosure. The resource control unit 341 illustrated in FIG. 9 includes a quality information acquisition unit 3411, a traffic management unit 3412, a priority information acquisition unit 3413, a priority determination unit 3414, a transmission power setting unit 3415, a resource allocation unit 3416, and a link adaptation unit 3418.

### (Quality Information Acquisition Unit 3411)

The quality information acquisition unit 3411 acquires information regarding communication quality of radio communication between the base station 30 and the UE 40 from the communication quality measurement unit 344.

### (Traffic Management Unit 3412)

The traffic management unit 3412 determines communication parameters (for example, a ratio between downlink and uplink), for example, on the basis of the total traffic volume and the link capacity. The information regarding the total traffic volume and the link capacity may be included in the priority information from the core network 200, for example. Alternatively, the traffic management unit 3412 may estimate the total traffic volume according to the notification from the UE 40 and estimate the link capacity according to the communication quality.

The traffic management unit 3412 handles, for example, the traffic volume of radio communication with the UE 40. The traffic management unit 3412 notifies the priority determination unit 3414 of the determined communication parameters.

### (Priority Information Acquisition Unit 3413)

The priority information acquisition unit 3413 acquires priority information from the core network 200 via the AMF 241. The priority information includes, for example, information regarding priority of the PDU session and information regarding a network slice determined by the NSSF 244.

The priority information acquisition unit 3413 notifies the priority determination unit 3414 of the acquired priority information.

### (Priority Determination Unit 3414)

The priority determination unit 3414 determines a level of priority of the PDU session in the radio communication on the basis of the communication parameters determined by the traffic management unit 3412 and the priority information acquired by the priority information acquisition unit 3413.

The priority determination unit 3414 notifies the transmission power setting unit 3415, the resource allocation unit 3416, and the link adaptation unit 3418 of the information regarding the determined level of priority of the PDU session.

### (Transmission Power Setting Unit 3415)

The transmission power setting unit 3415 sets a transmission power value of the UE 40 for each PDU session according to the level of priority determined by the priority determination unit 3414. For example, the transmission power setting unit 3415 sets the transmission power value such that the transmission power is higher as the level of priority of the PDU session is higher. For example, in a case of setting the transmission power value of a PDU session with a high level of priority, the transmission power setting unit 3415 may set target reception power at the base station 30 to be higher than that of a PDU session with a low level of priority.

The transmission power setting unit 3415 notifies the control information generation unit 342 of the set transmission power value.

### (Resource Allocation Unit 3416)

The resource allocating unit 3416 sets a resource to be allocated for each PDU session according to the level of priority determined by the priority determination unit 3414.

For example, the resource allocation unit 3416 calculates the number of resource blocks (RBs) per required unit time from the traffic volume of the PDU session with a high level of priority, and determines the number of allocated RBs and the allocation frequency of each slot. The resource allocation unit 3416 allocates RBs not used in the PDU session with a high level of priority to the PDU session with a low level of priority.

That is, the resource allocation unit 3416 allocates resources on the time axis and the frequency axis to a PDU session with a higher level of priority in descending order.

The resource allocation unit 3416 notifies the control information generation unit 342 of the set transmission power value.

### (Link Adaptation Unit 3418)

The link adaptation unit 3418 sets a modulation and coding scheme (MCS) for each PDU session according to the level of priority determined by the priority determination unit 3414.

For example, for a PDU session with a high level of priority, the link adaptation unit 3418 determines the MCS by setting a low target error rate. For a PDU session with a low level of priority, the resource allocation unit 3416 determines the MCS by setting a high target error rate. For example, for a PDU session with a high level of priority, the link adaptation unit 3418 determines the MCS by setting BLER (BLock Error Ratio)=10⁻². For a PDU session with a low level of priority, the link adaptation unit 3418 determines the MCS by setting BLER (BLock Error Ratio)=10⁻¹.

The link adaptation unit 3418 notifies the control information generation unit 342 of the determined MCS.

Note that the resource allocation unit 3416 may set an absolute value or a ratio to the entire radio link volume of the resource amount (for example, the number of RBs) that can be allocated to a PDU session with a high level priority. The transmission power setting unit 3415 may set the transmission power value (target reception power is a transmit power control (TPC) command). The link adaptation unit 3418 may determine the target error rate, and the control information generation unit 342 may determine the MCS.

### <3.3. Priority Setting Example>

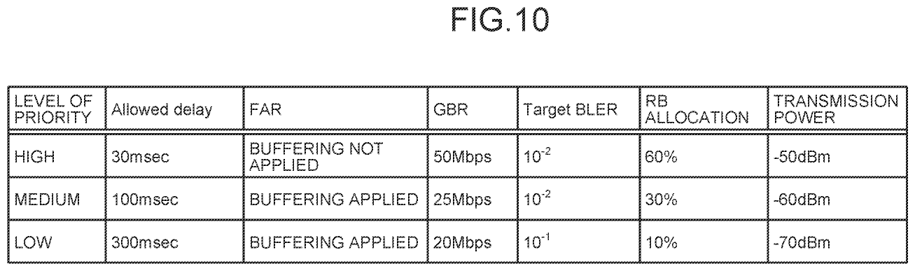

Next, a priority setting example in the communication system 1 according to the embodiment of the present disclosure will be described with reference to FIG. 10. FIG. 10 is a table illustrating a priority setting example in the communication system 1 according to the embodiment of the present disclosure.

In the example illustrated in FIG. 10, for the PDU session with a level of priority of “high”, “Allowed delay” is set to “30 msec”, “FAR” is set to “buffering not applied”, “GBR” is set to “50 Mbps”, and “Target BLER” is set to “10-2”. Also, for the PDU session with a high level of priority, “RB allocation” is set to “60%”, and “transmission power” is set to “−50 dBm”.

For the PDU session with a level of priority of “medium”, “Allowed delay” is set to “100 msec”, “FAR” is set to “buffering applied”, “GBR” is set to “25 Mbps”, and “Target BLER” is set to “10-2”. Also, for the PDU session with a high level of priority, “RB allocation” is set to “30%”, and “transmission power” is set to “−60 dBm”.

For the PDU session with a level of priority of “low”, “Allowed delay” is set to “300 msec”, “FAR” is set to “buffering applied”, “GBR” is set to “20 Mbps”, and “Target BLER” is set to “10-1”. Also, for the PDU session with a high level of priority, “RB allocation” is set to “10%”, and “transmission power” is set to “−70 dBm”.

Note that “RB allocation” indicates a ratio of usable resources in the allocatable resources. Also, “transmission power” indicates target reception power Po out of the parameters of the transmission power control.

“Allowed delay” illustrated in FIG. 10 is set by the information processing device 10 and is notified to the core network 200. “FAR” and “GBR” are set by the SMF 242 of the core network 200 on the basis of a notification from the information processing device 10, and are notified to the UPF 221.

“Target BLER”, “RB allocation”, and “transmission power” are set in the base station 30 on the basis of priority information notified from the SMF 242 via the AMF 241.

Note that the above-described setting is an example, and items other than the items illustrated in FIG. 10 may be set according to the level of priority. For example, the resolution or the like of the preview image may be set according to the level of priority. Furthermore, some of the items illustrated in FIG. 10 do not need to be set according to the level of priority.

### <<4. Priority Processing>>

### <4.1. Priority Setting Processing by Information Processing Device>

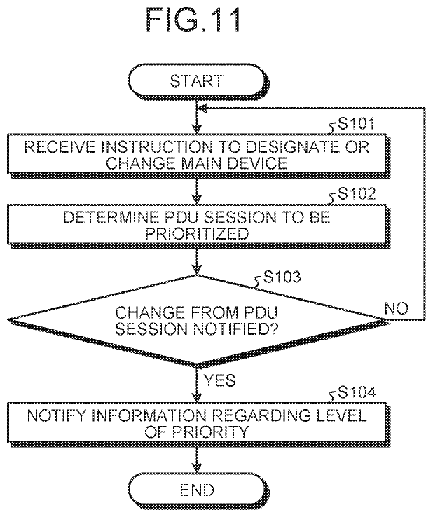

FIG. 11 is a flowchart illustrating an example of priority setting processing executed by the information processing device 10 according to the embodiment of the present disclosure. FIG. 11 illustrates a case where an instruction to designate or change the main device by the user is received, but similar processing is performed for other instructions to the main device such as a shutter instruction. For example, the information processing device 10 repeatedly executes the priority setting processing in FIG. 11 while an application for operating the control target device 60 is being activated.

As illustrated in FIG. 11, the information processing device 10 receives an instruction to designate or change the main device (step S101). Subsequently, the information processing device 10 determines a PDU session to be prioritized (step S102).

Subsequently, the information processing device 10 determines whether or not the PDU session determined in step S102 has been changed from the PDU session notified to the core network 200 (step S103).

In a case where the PDU session to be prioritized is not changed (step S103; No), the processing returns to step S101. On the other hand, in a case where the PDU session to be prioritized is changed from the notified PDU session (step S103; Yes), the information processing device 10 notifies the core network 200 of information regarding the level of priority of the determined PDU session (step S104).

### <4.2. Priority Setting Processing by Core Network>

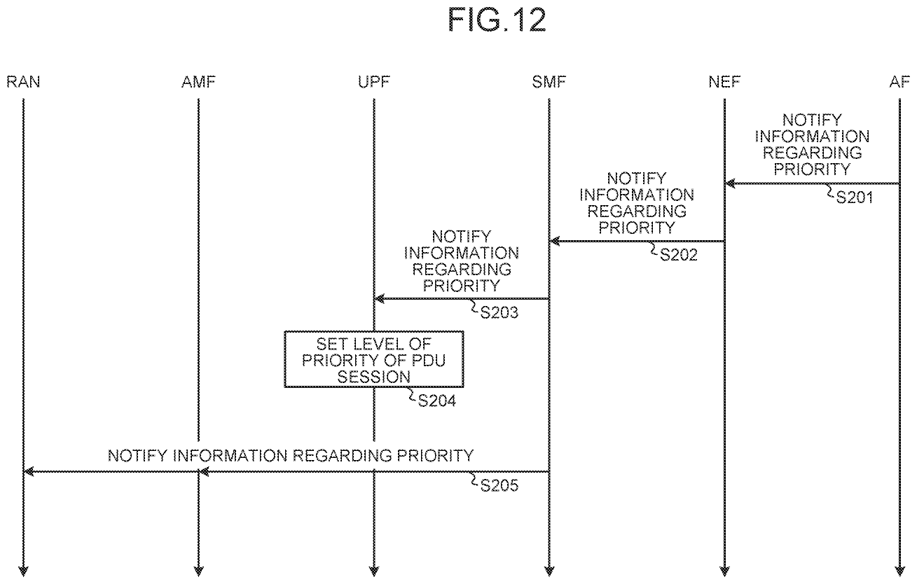

FIG. 12 is a sequence diagram illustrating an example of priority setting processing executed in the core network 200 according to the embodiment of the present disclosure. Note that FIG. 12 illustrates a case where the information processing device 10 is the AF.

As illustrated in FIG. 12, the AF notifies the NEF 245 of determined information (priority information) regarding priority (step S201). The NEF 245 notifies the SMF 242 of the received information regarding priority (step S202).

The SMF 242 notifies the UPF 221 of the information regarding priority (priority information) (step S203). The UPF 221 sets a level of priority of the PDU session on the basis of the received information regarding priority (step S204). In a case where the setting related to priority for the same application ID already exists, the UPF 221 overwrites the setting on the basis of the received priority.

In addition, the SMF 242 notifies the RAN (base station 30) of the information regarding priority (priority information) via the AMF 241 (step S205).

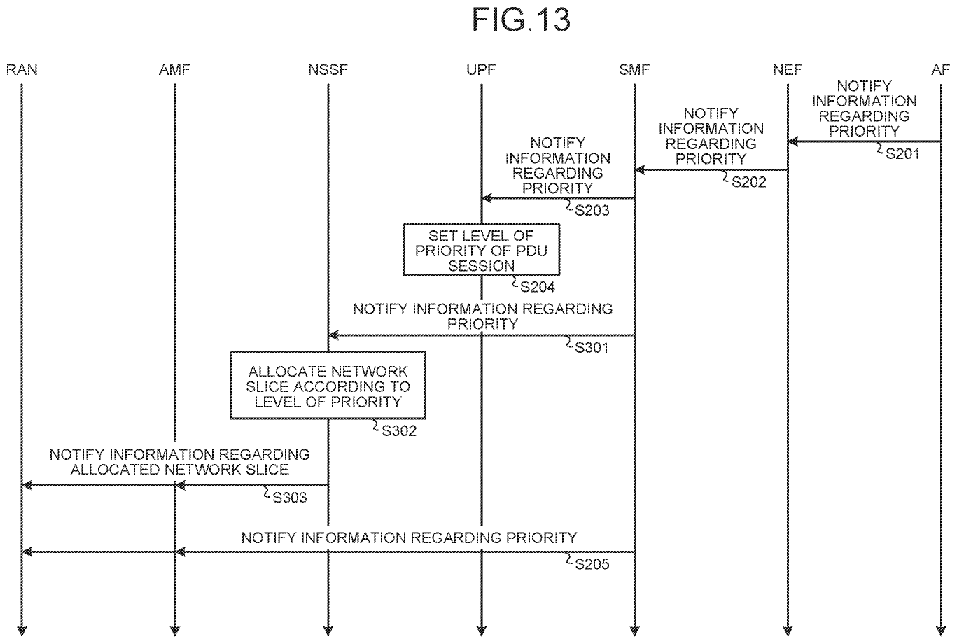

Note that, as described above, the SMF 242 may notify the NSSF 244 of the priority information, and the NSSF 244 may allocate a network slice according to the priority information. The priority setting processing in this case will be described with reference to FIG. 13. FIG. 13 is a sequence diagram illustrating another example of priority setting processing executed in the core network 200 according to the embodiment of the present disclosure. Note that the same steps as those in FIG. 12 are denoted by the same step numbers, and description thereof is omitted.

As illustrated in FIG. 13, the SMF 242 notifies the NSSF 244 of the information regarding priority (step S301). The NSSF 244 allocates a network slice according to the level of priority on the basis of the information regarding priority (step S302).

The NSSF 244 notifies the RAN (base station 30) of information regarding the allocated network slice via the AMF 241 (step S303). Note that the NSSF 244 may notify the SMF 242 and the UPF 221 of the slice information after determining the allocation of the network slice. In this case, on the basis of the slice information, the SMF 242 may perform session management, and the UPF 221 may perform data handling.

### <4.3. Priority Setting Processing by Base Station>

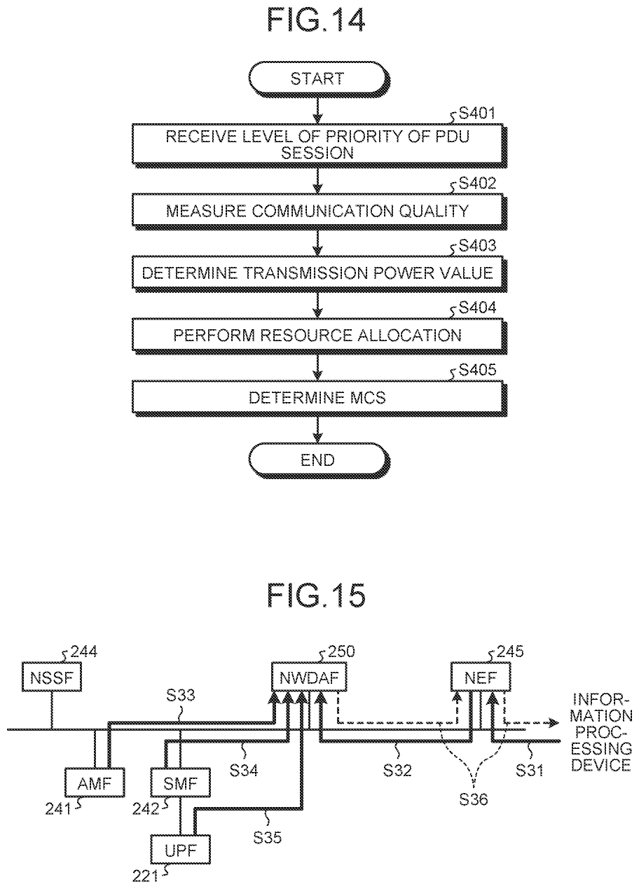

FIG. 14 is a flowchart illustrating an example of priority setting processing executed by the base station 30 according to the embodiment of the present disclosure. For example, the base station 30 repeatedly executes the priority setting processing in FIG. 14 while an application for operating the control target device 60 is being activated.

As illustrated in FIG. 14, the base station 30 receives information regarding a level of priority of the PDU session from the core network 200 (step S401). The base station 30 measures the communication quality between the base station 30 and the UE 40 (step S402).

On the basis of the level of priority of the PDU session and the measured communication quality, the base station 30 determines a transmission power value (step S403), performs resource allocation (step S405), and determines the MCS (step S406).

In this manner, in the communication system 1 according to the present embodiment, the information processing device 10 sets levels of priority of a plurality of pieces of traffic (for example, PDU sessions) according to control over the control target device 60. The core network 200 and the base station 30 perform priority control of traffic on the basis of the levels of priority set by the information processing device 10.

As a result, the communication system 1 can appropriately perform priority control of a plurality of pieces of traffic in the control over the control target device 60.

### <<5. Modification Examples>>

### (Buffering Information)

In the embodiment described above, the UE 40 performs uplink buffering according to the level of priority, but at this time, the UE 40 may notify the information processing device 10 of the status of buffering.

Here, for example, it is assumed that the captured image of the control target device 60 is transmitted to the information processing device 10 so that the captured image is displayed on the input/output device 50 as a preview, for example. In addition, it is assumed that the captured image of the control target device 60 is transmitted to the cloud server and the MEC 260. Note that the image quality of the captured image as a preview transmitted to the information processing device 10 does not need to be high, and the captured image may be transmitted with low image quality. In addition, it is assumed that the captured image transmitted to the cloud server and the MEC 260 is an uncompressed or lossless compressed high-quality image.

In addition, since the captured image has a longer allowable delay time than the preview image, and the level of priority of uplink traffic for the captured image is low, the data volume for buffering increases depending on the link volume.

Under such circumstances, the UE 40 holds the buffering time of the captured image, the buffered data size, the total data volume, and the like as buffering information. Note that the number of captured images corresponding to the buffering information held by the UE 40 is not limited to one, and may be plural (two or more).

The UE 40 notifies the core network 200 of the held buffering information via the AMF 241. The core network 200 notifies the information processing device 10 of the received buffering information via the NEF 245. The NEF 245 notifies the information processing device 10 of the buffering information by using, for example, Nnef_AfsessionWithQoS.

The communication system 1 may change the priority setting of the PDU session on the basis of the buffering information. For example, the base station 30 decreases the ratio of “RB allocation” of the PDU session whose level of priority is “high” from “60%” to “50%”. Further, the base station 30 increases the ratio of the “RB allocation” of the PDU session whose level of priority is “medium” from “30%” to “40%”. As a result, the ratio of the number of RBs allocated to the PDU session for transmitting the captured image whose level of priority is set to “medium” on the uplink increases. As a result, the communication system 1 can reduce the volume of buffered data (for example, the captured image).

Alternatively, the information processing device 10 may reduce the number of sub devices that temporarily display preview images. As a result, the communication system 1 can reduce the number of pieces of traffic whose level of priority is “low” and increase the number of RBs that can be used by the traffic transmitting the captured image, whose level of priority is “medium”, on the uplink. Therefore, the communication system 1 can reduce the volume of buffered data (for example, the captured image).

Note that the buffering information is an example of the above-described information regarding communication, and the level of priority of the traffic for the buffering information can be set to “medium”.

### (5GVN (Virtual Private Network))

Furthermore, in the above-described embodiment, the communication system 1 can include the plurality of control target devices 60, and the communication system 1 may cause the plurality of control target devices 60 to form, for example, 5GVN.

In this case, the information processing device 10 instructs all the control target devices 60 targeted for control to form a 5GVN group at a time when the remote control over the control target devices 60 is started, such as a time when an application for controlling the control target devices 60 is activated. The information processing device 10 instructs the control target devices 60 to form the 5GVN group by using, for example, Nnef_ParameterProvision. Such an instruction is an example of the above-described information regarding communication, and the level of priority of the traffic for issuing the instruction can be set to “medium”. For example, the level of priority of traffic of a device included in the 5GVN group is set to be higher than that of traffic of a device not included in the 5GVN group. As a result, the communication system 1 of the present embodiment can be operated more stably.

### (Transmission of Control Information Via NEF)

Furthermore, in the above-described embodiment, control information toward the main device such as a shutter instruction, autofocus, and zoom is notified as user data from the information processing device 10 to the UE 40, but the present invention is not limited thereto. For example, the information processing device 10 may notify the UE 40 of the above-described control information using Nnef_Trigger. In this case, the application of the UE 40 and the application of the control target device 60 can communicate with each other, and the UE 40 can control the control target device 60 using the control information.

Note that the information processing device 10 may transmit the control information using both the downlink and Nnef_Trigger, or may transmit the control information using one of the downlink and Nnef_Trigger. The information processing device 10 transmits the control information using both the downlink and Nnef_Trigger, so that the information processing device 10 can ensure redundancy of transmission of the control information. In addition, the UE 40 can control the main device using the control information transmitted using the downlink or the control information transmitted using Nnef_Trigger, which has reached earlier. As a result, the communication system 1 can control the main device with a lower delay.

### (Priority Change According to Statistical Analysis Result)

Furthermore, in the above-described embodiment, for example, the information processing device 10 sets a level of priority according to the actual traffic volume, but the present invention is not limited thereto. For example, the information processing device 10 may set a level of priority on the basis of statistical information such as a traffic volume in a predetermined period. For example, the information processing device 10 may change the priority setting of traffic (or PDU session) on the basis of an analysis result of the network performed by the core network 200.

The analysis of the network is performed by the NWDAF 250 of the core network 200, as described above. The information processing device 10 checks the traffic volume and the communication state of the network on the basis of the measurement values and the statistical values of the network derived by the NWDAF 250. The information processing device 10 increases or decreases the number of control target devices 60 as main devices on the basis of the checked information. Alternatively, the information processing device 10 increases or decreases the delay time allowed for the preview of the captured image or the upload to the cloud server. Alternatively, the information processing device 10 may perform the priority setting such that the ratio of RB allocation for each level of priority is changed.

FIG. 15 is a diagram for describing a flow of processing according to a modification example of the embodiment of the present disclosure. Note that FIG. 15 mainly illustrates functions related to the processing, and does not illustrate some other functions.

The NEF 245 acquires application information from the information processing device 10 (step S31). The information processing device 10 notifies the NEF 245 of the application information by using, for example, Nnef_EventExposure.

Here, examples of the application information notified by the information processing device 10 include the following information.
Set already with the application ID
IP filter information (service flow identification of the UE 40 for the application)
Application location
Service experience
Time stamp

Note that the application location described above is, for example, the location of the application represented by DNAI, and in a case where the DNAI used in the application is statically defined, the NEF 245 maps the DNAI list to AF service identifier.

The NEF 245 notifies the NWDAF 250 of the acquired application information (step S32).

The NWDAF 250 acquires UE information from the AMF 241 (step S33). The UE information may include, for example, a UE location and a SUPI list.

The NWDAF 250 acquires management information from the SMF 242 (step S34). The management information may include, for example, DNN, S-NSSAI, an application ID, IP filter information, and a QoS flow identifier (QFI).

The NWDAF 250 acquires data information from the UPF 221 (step S35). The data information may include, for example, QoS flow bit rate, QoS flow packet delay, packet transmission (the number of observed transmission packets), and packet retransmission (the number of times of observed packet retransmission).

The NWDAF 250 analyzes the network on the basis of the information acquired from the information processing device 10, the AMF 241, the SMF 242, and the UPF 221, and notifies the information processing device 10 of the analysis result as event information via the NEF 245 (step S36). The information processing device 10 acquires the event information using, for example, Nnef_AnalyticsExposure.

Examples of the event information notified by the NWDAF 250 include the following information.
Slice load level
Observed service experience information
NF load information (load statistics or predictions)
NW performance information
Statistics or predictions on UE 40 mobility
Statistics or predictions on UE 40 communication
Expected UE behavioral parameters
UE 40 abnormal behavior parameters
User data congestion information
QoS sustainability

The NW performance information may include, for example, statistics or predictions on the load in an area of interest, and statistics or predictions on the number of UEs 40 that are located in that area of interest.

The information processing device 10 changes the level of priority of the traffic according to the event information. For example, in a case where the event information is user data congestion information, the information processing device 10 performs control of the number of main devices, traffic volume control, delay time control of data with a low level of priority, and the like according to the user data congestion information. Furthermore, for example, in a case where the event information is QoS sustainability, the information processing device 10 performs control such as sustainment or change of image quality of the preview image according to the QoS sustainability.

### (Positional Information)

Furthermore, in the above-described embodiment, the preview image and the captured image are transmitted from the control target device 60 to the information processing device 10, but the present invention is not limited thereto. The control target device 60 may notify the information processing device 10 of information regarding the control target device 60, such as positional information of the control target device 60. The information processing device 10 acquires the positional information of the control target device 60 from the control target device 60 via the NEF 245 using, for example, Nnef_Location.

The information processing device 10 notifies an application that controls the control target device 60 of the acquired positional information of the control target device 60. The application manages the status of the control target device 60 such as the image capturing status on the basis of the positional information.

Alternatively, the information processing device 10 may cause the input/output device 50 to display the position of the control target device 60 on the basis of the acquired positional information so that the user can select the main device according to the position of the control target device 60. As a result, the user can select the main device according to the image capturing range or the like of the control target device 60.

Note that the above-described services provided by the NEF 245, such as Nnef_Location and Nnef_AnalyticsExposure, are examples. The information processing device 10 may exchange information with the core network 200 using a service provided by the NEF 245 in addition to the above-described services.

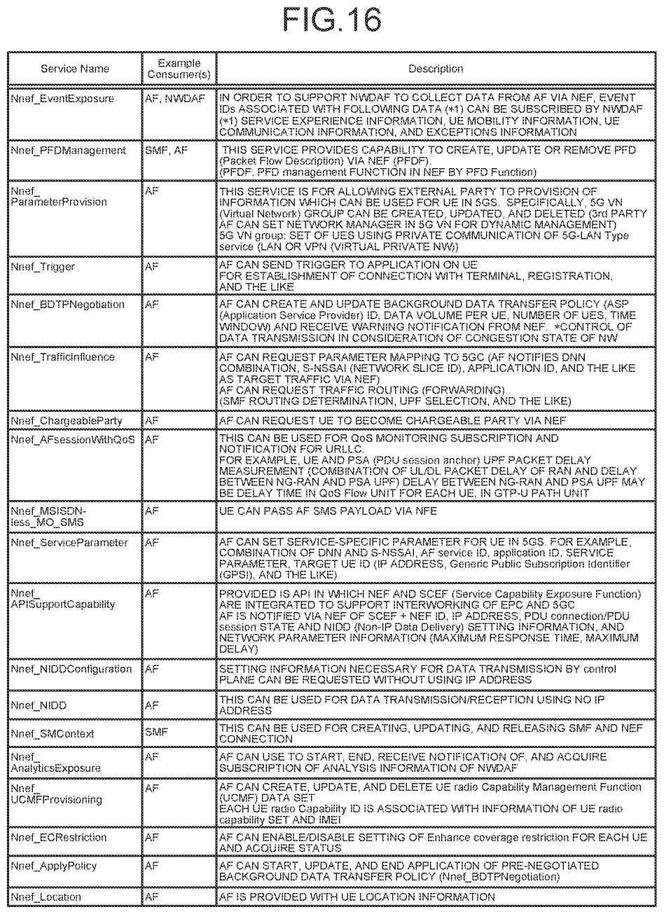

FIG. 16 illustrates examples of services provided by the NEF 245. FIG. 16 is a diagram illustrating examples of services provided by the NEF 245. The services provided by the NEF 245 are described in, for example, TS23.502 V16.8.0.

The information processing device 10 can achieve the technology of the present disclosure using the services illustrated in FIG. 16 in addition to the services used in the above-described embodiment.

### <<6. Other Embodiments>>

The above-described embodiment and modification examples are examples, and various changes and applications are possible.

For example, in the above-described embodiment and modification examples, the control target device 60 and the UE 40 are different devices, but the present invention is not limited thereto. For example, the control target device 60 and the UE 40 may be configured as one device. In this case, the UE 40 can function as, for example, a communication unit of the control target device 60.

For example, the control device that controls the information processing device 10 of the present embodiment may be achieved by a dedicated computer system or a general-purpose computer system.

For example, a communication program for executing the above-described operation is stored and distributed in a computer-readable recording medium such as an optical disk, a semiconductor memory, a magnetic tape, and a flexible disk. Then, for example, the program is installed in a computer, and the above-described processing is executed to configure the control device. At this time, the control device may be a device outside the information processing device 10 (for example, a personal computer). Furthermore, the control device may be a device inside the information processing device 10 (for example, the control unit 130).

Also, the above communication program may be stored in a disk device included in a server device on a network such as the Internet so that the communication program can be downloaded to a computer. Also, the above-described function may be fulfilled by cooperation of an operating system (OS) and application software. In this case, a portion other than the OS may be stored in a medium and distributed, or the portion other than the OS may be stored in a server device and downloaded to a computer.

Also, among the pieces of processing described in the above embodiment, all or a part of the pieces of processing described as being performed automatically can be performed manually, or all or a part of the pieces of processing described as being performed manually can be performed automatically by a known method. In addition, the processing procedures, specific names, and information including various data and parameters illustrated in the specification and drawings can arbitrarily be changed unless otherwise specified. For example, the various types of information illustrated in each of the drawings are not limited to the illustrated information.

Also, each of the components of each of the devices illustrated in the drawings is functionally conceptual, and is not necessarily physically provided as illustrated in the drawings. That is, a specific form of distribution and integration of each device is not limited to the illustrated form, and all or a part thereof can functionally or physically be distributed and integrated in an arbitrary unit according to various loads, usage conditions, and the like. Note that this configuration by distribution and integration may be performed dynamically.

Also, the above-described embodiments can appropriately be combined in a region in which the processing contents do not contradict each other. Also, the order of the respective steps illustrated in the sequence diagram in the above-described embodiment can be changed as appropriate.

Furthermore, for example, the present embodiment can be achieved as any configuration constituting a device or a system, such as a processor as a system large scale integration (LSI) or the like, a module using a plurality of processors or the like, a unit using a plurality of modules or the like, and a set obtained by further adding other functions to a unit (that is, a configuration as a part of the device).

Note that, in the present embodiment, the system means a set of a plurality of components (devices, modules (parts), or the like), and it does not matter whether or not all the components are in the same housing. Therefore, a plurality of devices housed in separate housings and connected via a network and one device in which a plurality of modules is housed in one housing are both systems.

Furthermore, for example, the present embodiment can adopt a configuration of cloud computing in which one function is shared and processed by a plurality of devices in cooperation via a network.

### <<7. Conclusion>>

Although the embodiment of the present disclosure has been described above, the technical scope of the present disclosure is not limited to the above-described embodiment, and various modifications can be made without departing from the gist of the present disclosure. Also, the components in the different embodiments and modification examples may appropriately be combined.

Further, the effects of the respective embodiments described in the present specification are illustrative only and are not limited, and other effects may be provided.

Note that the present technology can also employ the following configuration.

(1)

An information processing device that controls at least one device by means of communication via a core network, the information processing device comprising:
a control unit that determines levels of priority of a plurality of pieces of traffic to and from the device according to control over the device, and
that notifies the core network of priority information regarding the levels of priority.

(2)

The information processing device according to (1), wherein the control unit notifies the core network of the priority information via a network exposure function (NEF).

(3) The information processing device according to (1) or (2), wherein the priority information includes information regarding a selected device selected by a user as a control target among the plurality of devices.

(4)

The information processing device according to any one of (1) to (3), wherein the priority information includes at least one of information regarding a PFD of the traffic and information regarding a delay.

(5)

The information processing device according to any one of (1) to (4), wherein the priority information is used for setting a PDU session in the core network.

(6)

The information processing device according to any one of (1) to (5), wherein the level of priority is used for at least one of resource allocation control, transmission power control, and MCS control in a base station that is connected to the core network and communicates with the device.

(7)

The information processing device according to any one of (2) to (6), wherein the control unit acquires buffering information related to a buffering state of data transmitted by the device through the NEF, and changes the levels of priority of the plurality of pieces of traffic according to the buffering information.

(8)

The information processing device according to any one of (2) to (7), wherein the control unit transmits control information for controlling the device to the device via the NEF.

(9)

The information processing device according to any one of (2) to (8), wherein the control unit acquires analysis information regarding a network analysis result performed in the core network via the NEF, and changes the levels of priority of the plurality of pieces of traffic according to the analysis information.

(10)

An information processing method for controlling a device by means of communication via a core network, the information processing method comprising:
determining levels of priority of a plurality of pieces of traffic to and from the device according to control over the device; and
notifying the core network of priority information regarding the levels of priority.

(11)

A communication system comprising:
a core network;
an information processing device that controls a device by means of communication via the core network; and
a base station that performs radio communication with the device,
wherein the information processing device includes
a control unit that determines levels of priority of a plurality of pieces of traffic to and from the device according to control over the device, and
that notifies the core network of priority information regarding the levels of priority,
wherein the core network includes
a control unit that determines the levels of priority of the plurality of pieces of traffic according to the priority information notified from the information processing device, and
that notifies the base station of information regarding the levels of priority determined, and
wherein the base station includes
a control unit that performs radio communication with the device on a basis of the information regarding the levels of priority notified from the core network.

### REFERENCE SIGNS LIST

1 COMMUNICATION SYSTEM
10 INFORMATION PROCESSING DEVICE
20 SERVER
30 BASE STATION
40 TERMINAL DEVICE
50 INPUT/OUTPUT DEVICE
60 CONTROL TARGET DEVICE
110, 330 NETWORK COMMUNICATION UNIT
120, 320 STORAGE UNIT
130, 340 CONTROL UNIT
310 RADIO COMMUNICATION UNIT
200 CORE NETWORK

1. An information processing device that controls at least one device by means of communication via a core network, the information processing device comprising:
a control unit that determines levels of priority of a plurality of pieces of traffic to and from the device according to control over the device, and
that notifies the core network of priority information regarding the levels of priority.

2. The information processing device according to claim 1, wherein the control unit notifies the core network of the priority information via a network exposure function (NEF).

3. The information processing device according to claim 1, wherein the priority information includes information regarding a selected device selected by a user as a control target among the plurality of devices.

4. The information processing device according to claim 1, wherein the priority information includes at least one of information regarding a PFD of the traffic and information regarding a delay.

5. The information processing device according to claim 1, wherein the priority information is used for setting a PDU session in the core network.

6. The information processing device according to claim 1, wherein the level of priority is used for at least one of resource allocation control, transmission power control, and MCS control in a base station that is connected to the core network and communicates with the device.

7. The information processing device according to claim 2, wherein the control unit
acquires buffering information related to a buffering state of data transmitted by the device through the NEF, and
changes the levels of priority of the plurality of pieces of traffic according to the buffering information.

8. The information processing device according to claim 2, wherein the control unit transmits control information for controlling the device to the device via the NEF.

9. The information processing device according to claim 2, wherein the control unit
acquires analysis information regarding a network analysis result performed in the core network via the NEF, and
changes the levels of priority of the plurality of pieces of traffic according to the analysis information.

10. An information processing method for controlling a device by means of communication via a core network, the information processing method comprising:
determining levels of priority of a plurality of pieces of traffic to and from the device according to control over the device; and
notifying the core network of priority information regarding the levels of priority.

11. A communication system comprising:
a core network;
an information processing device that controls a device by means of communication via the core network; and
a base station that performs radio communication with the device,
wherein the information processing device includes
a control unit that determines levels of priority of a plurality of pieces of traffic to and from the device according to control over the device, and
that notifies the core network of priority information regarding the levels of priority,
wherein the core network includes
a control unit that determines the levels of priority of the plurality of pieces of traffic according to the priority information notified from the information processing device, and
that notifies the base station of information regarding the levels of priority determined, and
wherein the base station includes
a control unit that performs radio communication with the device on a basis of the information regarding the levels of priority notified from the core network.
